(19) United States
(12) Patent Application Publication
(10) Pub. No.: US 2019/0068356 A1
(43) Pub. Date: Feb. 28, 2019

(54) IMPULSE GENERATION CIRCUIT AND WIRELESS COMMUNICATION APPARATUS

(71) Applicant: FUJITSU LIMITED, Kawasaki-shi (JP)

(72) Inventor: Hiroshi Matsumura, Atsugi (JP)

(73) Assignee: FUJITSU LIMITED, Kawasaki-shi (JP)

(21) Appl. No.: 16/105,049

(22) Filed: Aug. 20, 2018

(30) Foreign Application Priority Data
Aug. 22, 2017 (JP) 2017-159642

(51) Int. Cl. H04L 7/04; H04L 27/20

(52) U.S. Cl. CPC H04L 7/04; H04B 10/548; H04L 27/20

(57) ABSTRACT

An impulse generation circuit includes a first impulse signal generation circuit configured to generate a first impulse signal based on a clock signal; a phase modulator configured to generate a second local signal by phase-modulating a first local signal; and a second impulse signal generation circuit configured to generate a second impulse signal by mixing the first impulse signal and the second local signal, the second impulse signal being a phase-modulated impulse signal.

### CROSS-REFERENCE TO RELATED APPLICATION

This application is based upon and claims the benefit of priority of the prior Japanese Patent Application No. 2017-159642, filed on Aug. 22, 2017, the entire contents of which are incorporated herein by reference.

### FIELD

The embodiment discussed herein is related to an impulse generation circuit and a wireless communication apparatus.

### BACKGROUND

A pulse position modulation circuit that transmits data by changing a temporal position of a pulse has been known.

Examples of the related art include Japanese Laid-open Patent Publication No. 2009-232445 and Japanese Laid-open Patent Publication No. 2008-288732.

### SUMMARY

According to an aspect of the invention, an impulse generation circuit includes a first impulse signal generation circuit configured to generate a first impulse signal based on a clock signal; a phase modulator configured to generate a second local signal by phase-modulating a first local signal; and a second impulse signal generation circuit configured to generate a second impulse signal by mixing the first impulse signal and the second local signal, the second impulse signal being a phase-modulated impulse signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a wireless communication apparatus including an impulse generation circuit;

FIG. 2 is a diagram illustrating an example of a configuration of an impulse generation circuit (comparative example);

FIG. 3 is a diagram illustrating an example of a configuration of an impulse generation circuit (embodiment);

FIG. 4 is a diagram illustrating a first configuration example of a quadrature coupler;

FIG. 5 is a diagram illustrating a second configuration example of the quadrature coupler;

FIG. 6 is a diagram illustrating a first configuration example of a balun;

FIG. 7 is a diagram illustrating a second configuration example of the balun;

FIG. 8 is a diagram illustrating an example of a configuration of an impulse generation circuit (embodiment);

FIG. 9 is a diagram illustrating an example of a configuration of a clock data recovery circuit;

FIG. 10 is a diagram illustrating an example of a result of simulating a variation of phase difference; and

FIG. 11 is a diagram illustrating an example of a configuration of an impulse generation circuit (embodiment).

### DESCRIPTION OF EMBODIMENT

A conventional pulse position modulation circuit realizes multi-level modulation that transmits a signal of a plurality of bits per symbol waveform by using a plurality of delay devices that generate a plurality of different delay times according to input data. However, variation of delay time generated by each delay device is relatively large, so that the accuracy of the multi-level modulation may be degraded.

Therefore, the present disclosure presents an impulse generation circuit and a wireless communication apparatus that may realize highly accurate multi-level modulation.

Hereinafter, the impulse generation circuit and the wireless communication apparatus related to the present disclosure will be described.

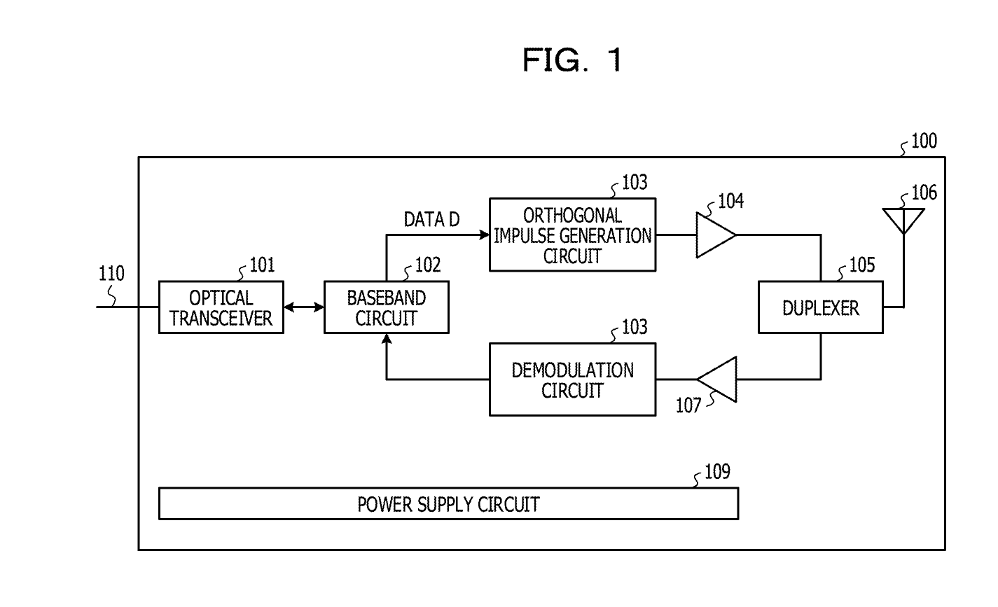

FIG. 1 is a diagram illustrating an example of a configuration of the wireless communication apparatus including the impulse generation circuit. The wireless communication apparatus 100 illustrated in FIG. 1 performs wireless communication by an impulse system that uses an RF (Radio Frequency) pulse as a transmission medium.

The wireless communication apparatus 100 includes, for example, an optical transceiver 101, a baseband circuit 102, an orthogonal impulse generation circuit 103, a power amplifier 104, a duplexer 105, an antenna 106, a low noise amplifier 107, a demodulation circuit 108, and a power supply circuit 109.

The optical transceiver 101 is an example of a transceiver. The optical transceiver 101 is a circuit that transmits and receives information to and from an external apparatus (not illustrated in the drawings) connected to the wireless communication apparatus 100 through an optical fiber 110. The optical transceiver 101 transmits information received from the external apparatus through the optical fiber 110 to the baseband circuit 102 and transmits information acquired from the baseband circuit 102 to the external apparatus through the optical fiber 110.

The baseband circuit 102 generates baseband data D based on information acquired from the optical transceiver 101 and transmits the baseband data D to the orthogonal impulse generation circuit 103. The baseband data D is an example of a baseband signal. Further, the baseband circuit 102 reproduces information included in a reception signal (impulse signal) wirelessly received through the antenna 106 from baseband data obtained by demodulation by the demodulation circuit 108. The baseband circuit 102 transmits reproduced information to the optical transceiver 101. The baseband circuit 102 is formed by, for example, FPGA (Field-Programmable Gate Array).

The orthogonal impulse generation circuit 103 is an example of an impulse generation circuit that generates a multi-valued impulse signal. The orthogonal impulse generation circuit 103 generates a multi-level modulated impulse signal according to the baseband data D inputted from the baseband circuit 102. The impulse signal outputted from the orthogonal impulse generation circuit 103 is inputted into the power amplifier 104. The impulse signal (transmission signal) amplified by the power amplifier 104 is wirelessly transmitted through the duplexer 105 and the antenna 106.

The duplexer 105 is a branching filter that electrically separates a transmission path that transmits a transmission signal through the antenna 106 and a reception path that receives a reception signal through the antenna 106 from each other.

The reception signal (impulse signal) wirelessly received through the antenna 106 is inputted into the demodulation circuit 108 through the duplexer 105 and the low noise amplifier 107.

The demodulation circuit 108 demodulates the reception signal (impulse signal) amplified by the low noise amplifier 107 to generate baseband data. The demodulation circuit 108 transmits a generated baseband signal to the baseband circuit 102.

The power supply circuit 109 generates a power supply voltage to be supplied to each circuit (for example, the baseband circuit 102, the orthogonal impulse generation circuit 103, and the like) in the wireless communication apparatus 100.

When the wireless communication apparatus 100 does not have, for example, the duplexer 105, the low noise amplifier 107, and the demodulation circuit 108, the wireless communication apparatus 100 may be used as an impulse transmitter that transmits an impulse signal through the antenna 106.

By the way, as an impulse generation circuit that performs multi-level modulation, a position modulation impulse generation circuit that performs position modulation is considered.

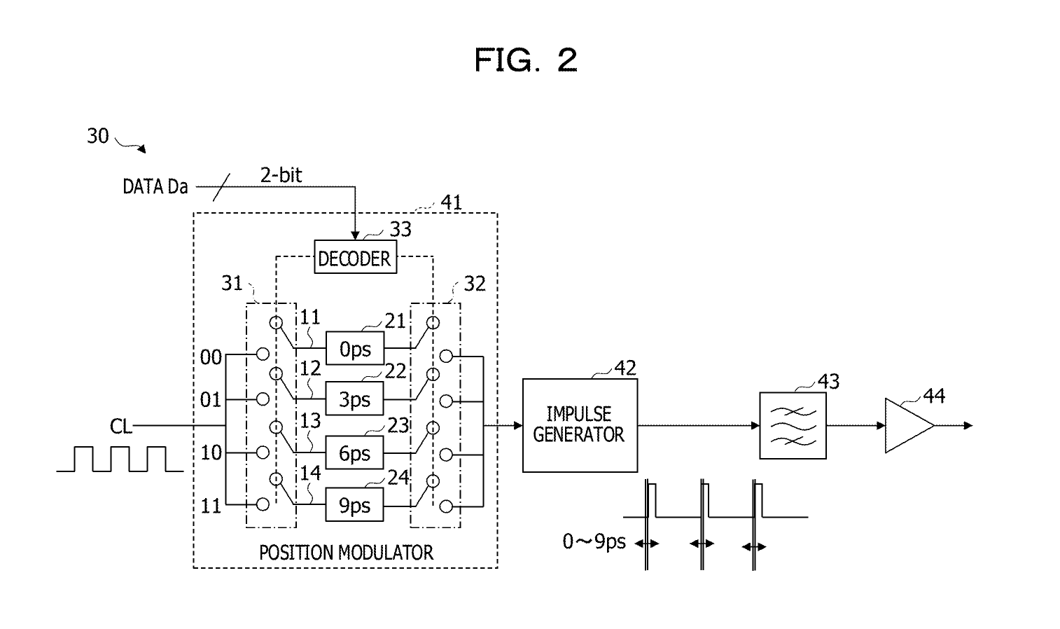

FIG. 2 is a diagram illustrating an example of a configuration of the position modulation impulse generation circuit. An impulse generation circuit 30 illustrated in FIG. 2 slightly changes (position-modulates) a temporal position of an outputted impulse signal (for example, a millimeter-wave signal with a transmission frequency of 83 GHz). Specifically, the impulse generation circuit 30 performs multi-level modulation by a time difference smaller than or equal to one cycle of the outputted impulse signal. In the example of FIG. 2, an impulse signal that is position-modulated by a time difference of ¼ cycle (3 ps) is generated. For example, the impulse generation circuit 30 operates as described below.

First, a clock signal CL (for example, frequency is 3 GHz) and a data signal Da (for example, transmission rate is 3 Gbps) are inputted into a position modulator 41. The position modulator 41 has four delay paths 11 to 14, a decoder 33, and switch circuits 31 and 32. The decoder 33 selects a path through which the clock signal CL passes from among the four delay paths 11 to 14 by the switch circuits 31 and 32 according to a value (00, 01, 10, or 11) of the data signal Da.

The delay paths 11 to 14 are respectively mounted with delay devices 21 to 24 having different delay times (0 ps, 3 ps, 6, ps, and 9 ps), respectively. A signal outputted from the position modulator 41 is a pulse signal having substantially the same frequency as that of the clock signal CL (for example, 3 GHz). The clock signal CL passes through a delay path different according to the value of the data signal Da, that is, a delay device different according to the value of the data signal Da. Therefore, four patterns of pulse signals that are position-modulated so that their rising positions are different from each other are outputted from the position modulator 41.

An impulse generator 42 generates an impulse at a rising position of the pulse signal outputted from the position modulator 41. Further, a post-stage bandpass filter 43 lets a signal component of only a predetermined passing frequency band (for example, a millimeter wave band whose center frequency is 83 GHz) pass through. The impulse generated by the impulse generator 42 spreads in a wide band in a frequency region. The bandpass filter 43 extracts only a frequency component in a passing frequency band of the impulse (for example, a millimeter wave component of 83 GHz band). A signal extracted by the bandpass filter 43 is amplified by an amplifier 44 and transmitted.

For example, the signal extracted in this way has a waveform where a wavelet of a millimeter wave band appears in a cycle corresponding to 3 GHz, and a position of the wavelet changes according to 3 ps ×N (N is an integer).

However, the circuit in FIG. 2 has a circuit configuration that switches a path through which the clock signal CL passes in order to realize a time difference of 3 ps that is finally outputted. A control voltage of a delay device for giving a time difference of 3 ps varies according to a process, a power supply voltage, and a temperature, so that it may be difficult for the position modulation impulse generation circuit in FIG. 2 to stably perform the multi-level modulation. For example, when the delay device is an active circuit including at least one active element (for example, a transistor or the like that is used as an amplification element), a variation of delay time of each delay device tends to be large due to a process, a power supply voltage, and a temperature of the active element. Therefore, the time difference of 3 ps may not be accurately realized.

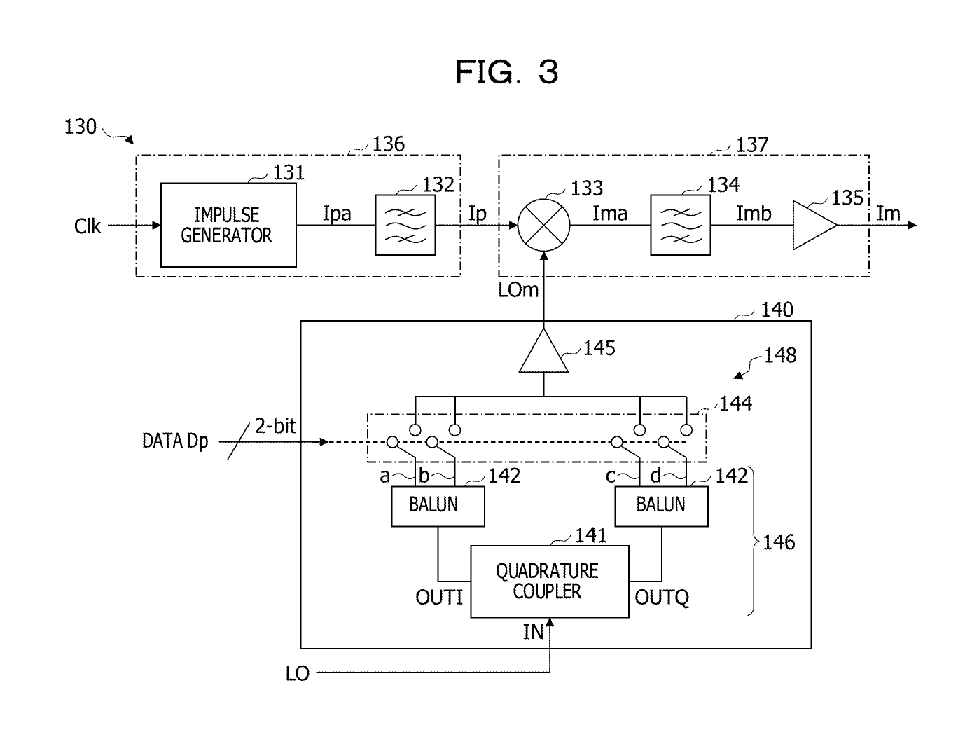

In this case, when products are shipped, if an optimal control voltage is inspected on all the products and in all conditions considering various power supply voltages and temperature changes, there is a risk of increasing inspection processes. Therefore, in the present disclosure, the impulse generation circuit illustrated in FIG. 3 is provided in order to accurately realize the multi-level modulation.

FIG. 3 is a diagram illustrating a first configuration example of an impulse generation circuit according to an embodiment of the present disclosure. An impulse generation circuit 130 illustrated in FIG. 3 is an example of the orthogonal impulse generation circuit 103 (see FIG. 1).

The impulse generation circuit 130 in FIG. 3 has a heterodyne configuration that generates an impulse signal Im (transmission signal) by generating a phase-modulated local signal LOm and mixing the local signal LOm and an impulse signal Ip.

For example, the frequency (intermediate frequency FIF) of the impulse signal Ip is set to a frequency obtained by dividing the frequency (transmission frequency Fc) of the impulse signal Im into ⅕ and the frequency (local frequency FLO) of the local signal LOm is set to a frequency obtained by multiplying the FIF by 4. When the Fc is 83.5 GHz, the FIF and the FLO are 16.7 GHz and 66.8 GHz, respectively.

The impulse generation circuit 130 includes an impulse generating circuit 136, a phase modulator 140, and an impulse generating circuit 137.

The impulse generating circuit 136 is an example of a first impulse signal generating circuit. The impulse generating circuit 136 generates the impulse signal Ip based on a clock signal Clk. For example, the frequency (clock frequency Fs) of the clock signal Clk is set to a frequency obtained by dividing the frequency (intermediate frequency FIF) of the impulse signal Ip into ⅕. When the FIF is 16.7 GHz, the Fs is 3.34 GHz. The impulse signal Ip is an example of a first impulse signal.

The impulse generating circuit 136 has, for example, an impulse generator 131 and a low-frequency bandpass filter 132.

The impulse generator 131 generates a pulse signal Ipa having a predetermined pulse width based on the clock signal Clk. The frequency of the pulse signal Ipa is the same as the clock frequency Fs of the clock signal Clk, and the pulse width of the pulse signal Ipa is smaller than the pulse width of the clock signal Clk. The impulse generator 131 outputs the pulse signal Ipa whose pulse width is smaller than that of the clock signal Clk at the same cycle as that of the clock signal Clk.

The low-frequency bandpass filter 132 is an example of a first filter. The low-frequency bandpass filter 132 outputs the impulse signal Ip by performing a filtering, which passes a signal component of only a predetermined passing frequency band, on the pulse signal Ipa generated by the impulse generator 131. The passing frequency band that is set in the low-frequency bandpass filter 132 is, for example, a millimeter wave band whose center frequency is 16.7 GHz. In other words, the low-frequency bandpass filter 132 outputs the impulse signal Ip having the intermediate frequency FIF (for example, 16.7 GHz) that is substantially the same as the center frequency of the predetermined passing frequency band.

The phase modulator 140 generates a phase-modulated local signal LOm by phase-modulating a local signal LO. The local signal LO is an example of a first local signal. The phase modulator 140 phase-modulates the local signal LO according to a data signal DP. The local signal LO, the data signal Dp, and the local signal LOm represent a carrier signal (carrier), a modulating signal, and a modulated signal, respectively. The phase modulator 140 will be described later in further detail.

The impulse generating circuit 137 is an example of a second impulse generating circuit. The impulse generating circuit 137 generates a phase-modulated impulse signal Im (transmission signal) by mixing the impulse signal Ip and the local signal LOm. The impulse signal Im is an example of a second impulse signal.

The impulse generating circuit 137 has, for example, a mixer 133, a high-frequency bandpass filter 134, and a transmission amplifier 135.

The mixer 133 is a circuit that outputs a mixer output signal Ima generated by mixing the impulse signal Ip and the local signal LOm. The mixer output signal Ima includes a signal component of a sum frequency that is a sum of the frequency of the local signal LOm and the frequency of the impulse signal Ip and a signal component of a difference frequency obtained by subtracting the frequency of the impulse signal Ip from the frequency of the local signal LOm. For example, the sum frequency of the mixer output signal Ima is 83.5 (=66.8+16.7) GHz, and the difference frequency of the mixer output signal Ima is 50.1 (=66.8-16.7) GHz.

The high-frequency bandpass filter 134 is an example of a second filter. The high-frequency bandpass filter 134 outputs an impulse signal Imb by performing a filtering, which passes a signal component of only a predetermined passing frequency band, on the mixer output signal Ima outputted from the mixer 133. The passing frequency band that is set in the high-frequency bandpass filter 134 is, for example, a millimeter wave band whose center frequency is the sum frequency of the mixer output signal Ima. In other words, the high-frequency bandpass filter 134 outputs the impulse signal Imb having the transmission frequency Fc (for example, 83.5 GHz) that is substantially the same as the center frequency of the predetermined passing frequency band.

It is possible to suppress a local leak of the local signal LOm by letting the mixer output signal Ima after the mixing by the mixer 133 pass through the high-frequency bandpass filter 134. The impulse signal Imb is supplied to the transmission amplifier 135.

The transmission amplifier 135 amplifies the impulse signal Imb and outputs the amplified impulse signal Im. The transmission amplifier 135 may be shared with the power amplifier 104 (see FIG. 1).

In this way, in the phase modulation impulse generation circuit of FIG. 3, the impulse signal Ip and the phase-modulated local signal LOm are mixed, so that the impulse signal Im that is multi-valued due to phase difference is generated.

Therefore, in the position modulation impulse generation circuit of FIG. 2, the multi-level modulation is realized by using a plurality of delay devices. On the other hand, in the phase modulation impulse generation circuit of FIG. 3, the multi-level modulation is realized by using the phase modulator 140 without using a plurality of delay devices, so that it is possible to improve accuracy of the multi-level modulation.

In particular, the phase modulator 140 illustrated in FIG. 3 has a passive circuit 148 formed including at least one passive element and generates the local signal LOm by phase-modulating the local signal LO by using the passive circuit 148. Specific examples of the passive element include a resistor, a capacitor, and a transistor used as a switch element. A characteristic variation due to process, power supply voltage, or temperature in a passive circuit formed including at least one passive element is smaller than that in an active circuit formed including at least one active element. Therefore, it is possible to further improve the accuracy of the multi-level modulation by using the phase modulator 140 having the passive circuit 148.

The passive circuit 148 illustrated in FIG. 3 has a phase shift circuit 146 and a switch circuit 144. The phase shift circuit 146 is formed including one quadrature coupler 141 and two baluns 142. The phase shift circuit 146 generates a plurality of (four in FIG. 3) output signals a to d whose phases are different from each other based on the local signal LO. The phases of the plurality of output signals a to d are 0°, 180°, 90°, and 270°. The phase modulator 140 generates the local signal LOm by switching the plurality of output signals a to d by switch circuit 144. The switch circuit 144 is formed including a plurality of transistors (for example, MOSFETs (Metal Oxide Semiconductor Field Effect Transistors) or the like) used as switch elements.

The switch circuit 144 selects the local signal LOm from among the plurality of output signals a to d according to a value (00, 01, 10, or 11) of the data signal Dp that is a 2-bit parallel data. Thereby, a phase-modulated local signal LOm (in other words, a local signal LOm that is multi-valued according to the value of the data signal Dp) is generated. The local signal LOm may be amplified by an amplifier 145 and supplied to the mixer 133.

When the value of the data signal Dp is “00”, the switch circuit 144 sets the output signal supplied to the mixer 133 to the output signal a. When the value of the data signal Dp is “01”, the switch circuit 144 sets the output signal supplied to the mixer 133 to the output signal b. When the value of the data signal Dp is “10”, the switch circuit 144 sets the output signal supplied to the mixer 133 to the output signal c. When the value of the data signal Dp is “11”, the switch circuit 144 sets the output signal supplied to the mixer 133 to the output signal d.

The quadrature coupler 141 is a circuit that generates a first coupler output signal and a second coupler output signal whose phase is 90° different from that of the first coupler output signal based on the local signal LO inputted from an input node IN. The quadrature coupler 141 outputs the first coupler output signal from an output node OUTI and outputs the second coupler output signal from an output node OUTQ.

One balun 142 generates a first balun output signal and a second balun output signal whose phase is 180° different from that of the first balun output signal based on the first coupler output signal outputted from the output node OUTI. The one balun 142 outputs the first balun output signal whose phase is 0° as the output signal a and outputs the second balun output signal whose phase is 180° as the output signal b.

The other balun 142 generates a third balun output signal and a fourth balun output signal whose phase is 180° different from that of the third balun output signal based on the second coupler output signal outputted from the output node OUTQ. The other balun 142 outputs the third balun output signal whose phase is 90° as the output signal c and outputs the fourth balun output signal whose phase is 270° as the output signal d.

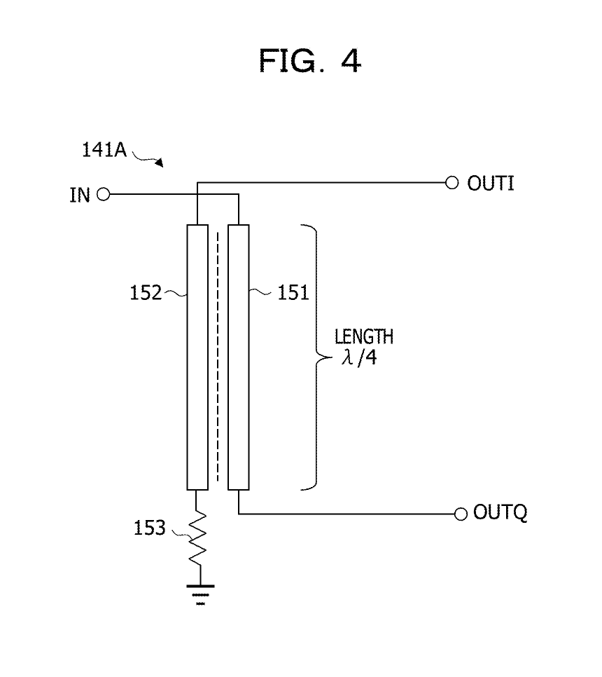

FIG. 4 is a diagram illustrating a first configuration example of a quadrature coupler. A quadrature coupler 141A illustrated in FIG. 4 is an example of the quadrature coupler 141 (see FIG. 3). The quadrature coupler 141A is a coupled line type 90° coupler in which two transmission lines 151 and 152 are connectably arranged in parallel with an interval. The transmission line 151 has one end connected to the input node IN and the other end connected to the output node OUTQ. The transmission line 152 has one end connected to the output node OUTI and the other end matched and terminated to a terminal potential through a terminal resistor 153 having an impedance equal to a characteristic impedance of the transmission line 152. An electrical length of each of the transmission lines 151 and 152 is λ/4 when a wavelength of a transmitted signal is λ.

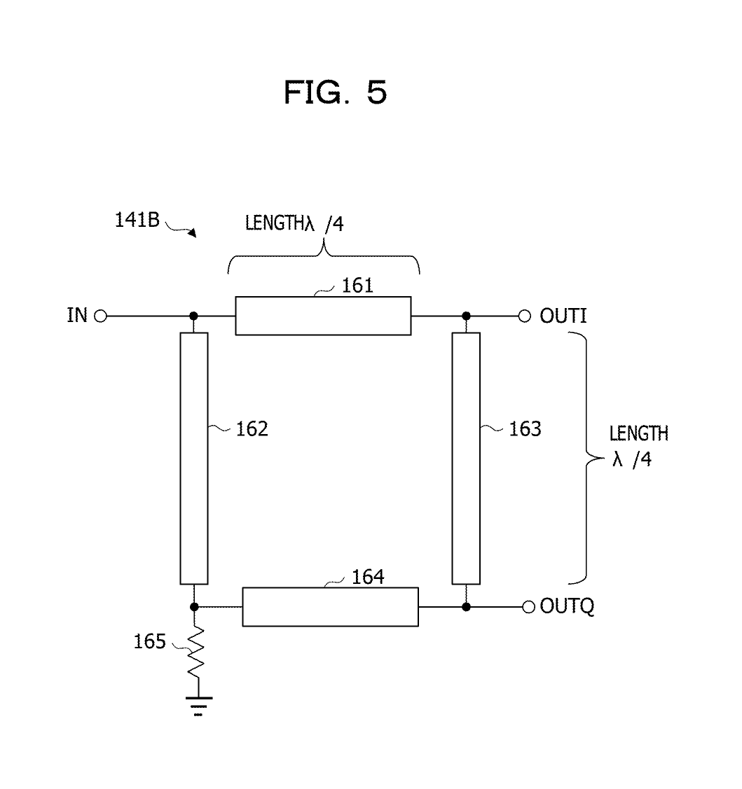

FIG. 5 is a diagram illustrating a second configuration example of the quadrature coupler. A quadrature coupler 141B illustrated in FIG. 5 is an example of the quadrature coupler 141 (see FIG. 3). The quadrature coupler 141B is a 90° hybrid coupler (branch line coupler) in which two transmission lines 162 and 163 having a characteristic impedance Z₀ and two transmission lines 161 and 164 having a characteristic impedance (Z₀/√2) are combined. For example, X0 is 50 Ω. The input node IN is connected to a connection node between the transmission line 161 and the transmission line 162. A connection node between the transmission line 162 and the transmission line 164 is matched and terminated to the terminal potential through a terminal resistor 165. The output node OUTQ is connected to a connection node between the transmission line 164 and the transmission line 163. The output node OUTI is connected to a connection node between the transmission line 163 and the transmission line 161. An electrical length of each of the transmission lines 161 to 164 is λ/4 when a wavelength of a transmitted signal is λ.

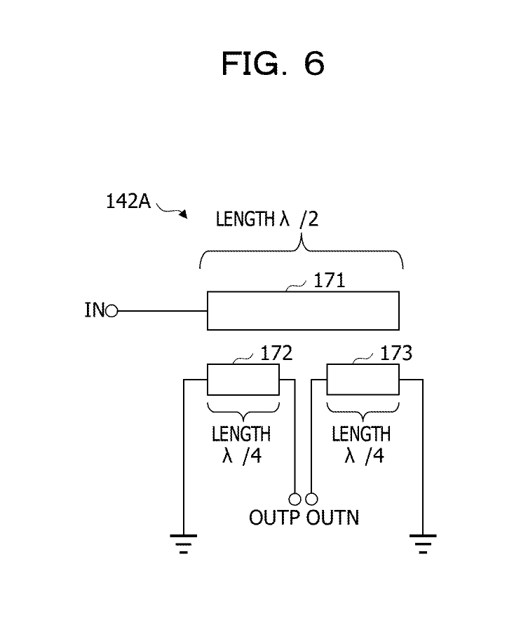

FIG. 6 is a diagram illustrating a first configuration example of a balun. A balun 142A illustrated in FIG. 6 is an example of the balun 142 (see FIG. 3). The balun 142A is a merchant balun where three transmission lines 171 to 173 are combined. The transmission lines 171 and 172 are arranged in parallel with an interval so as to be connectable to each other. The transmission lines 171 and 173 are arranged in parallel with an interval so as to be connectable to each other. The transmission line 171 has one end connected to the input node IN and an open end opposite to the one end. The transmission line 172 has one end directly terminated to the terminal potential and the other end connected to an output node OUTP. The transmission line 173 has one end directly terminated to the terminal potential and the other end connected to an output node OUTN. The electrical lengths of the transmission lines 171 to 173 are λ/2, λ/4, and λ/4, respectively, when a wavelength of a transmitted signal is λ.

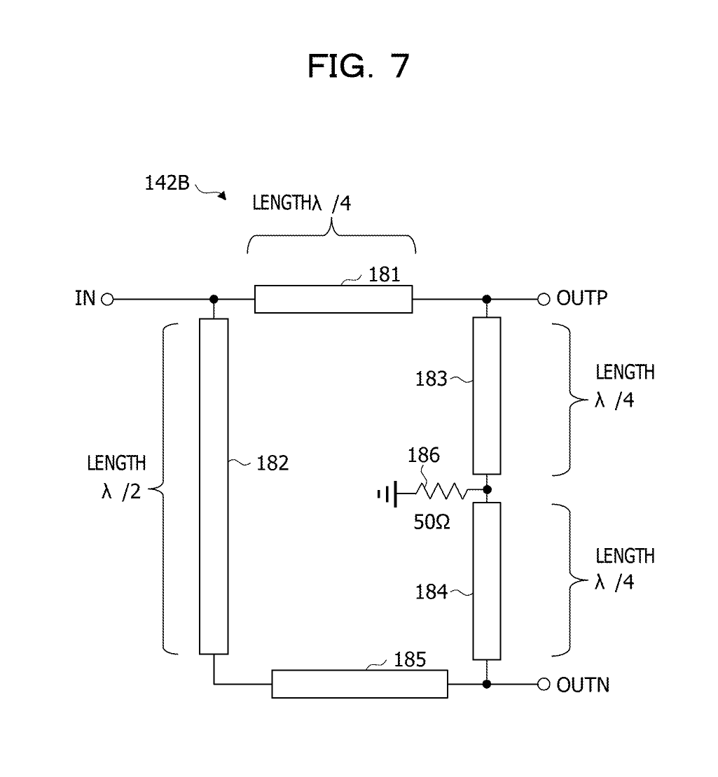

FIG. 7 is a diagram illustrating a second configuration example of the balun. A balun 142B illustrated in FIG. 7 is an example of the balun 142 (see FIG. 3). The balun 142B is a 180° hybrid coupler (rat race circuit) where five transmission lines 181 to 185 are combined. The input node IN is connected to a connection node between the transmission line 181 and the transmission line 182. A connection node between the transmission line 185 and the transmission line 184 is connected to the output node OUTN. A connection node between the transmission line 183 and the transmission line 181 is connected to the output node OUTP. A connection node between the transmission line 183 and the transmission line 184 is matched and terminated to the terminal potential through a terminal resistor 186. When the impedance of the terminal resistor 186 is 50 Ω, the characteristic impedance of the transmission lines 181 to 185 is 70.8 Ω. When a wavelength of a transmitted signal is λ, an electrical length of each of the transmission lines 181 and 183 to 185 is λ/4, and an electrical length of the transmission line 182 is λ/2.

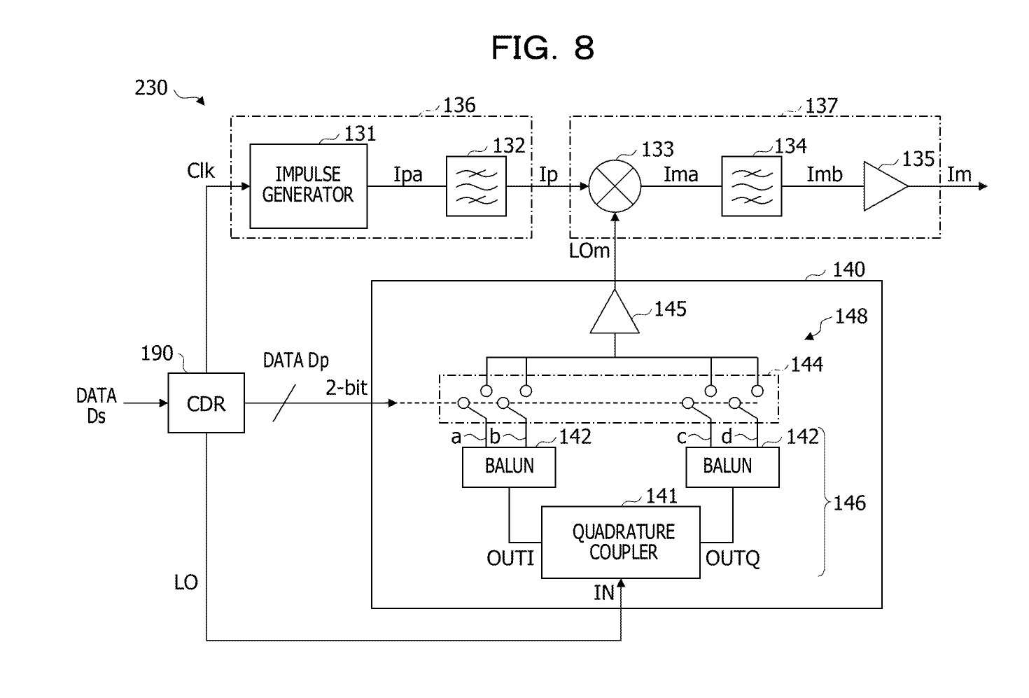

FIG. 8 is a diagram illustrating a second configuration example of the impulse generation circuit according to the embodiment of the present disclosure. In impulse system communication, a relationship that the frequency (transmission frequency Fc) of the impulse signal Im is an integral multiple of the frequency (clock frequency Fs) of the clock signal Clk is established. An impulse generation circuit 230 in FIG. 8 includes a CDR (Clock Data Recovery) circuit 190 in order to establish the above relationship.

A CDR circuit 190 is a synchronization circuit that generates a clock signal Clk and a local signal LO and synchronizes the clock signal Clk and the local signal LO so that a ratio between the frequencies of the clock signal Clk and the local signal LO is an integer ratio. The CDR circuit 190 reproduces a data signal Dp (parallel data) and the clock signal Clk from a data signal Ds (serial data) and generates the local signal LO synchronized with the data signal Ds. The data signal Ds inputted into the CDR circuit 190 is generated by, for example, the baseband circuit 102 (see FIG. 1).

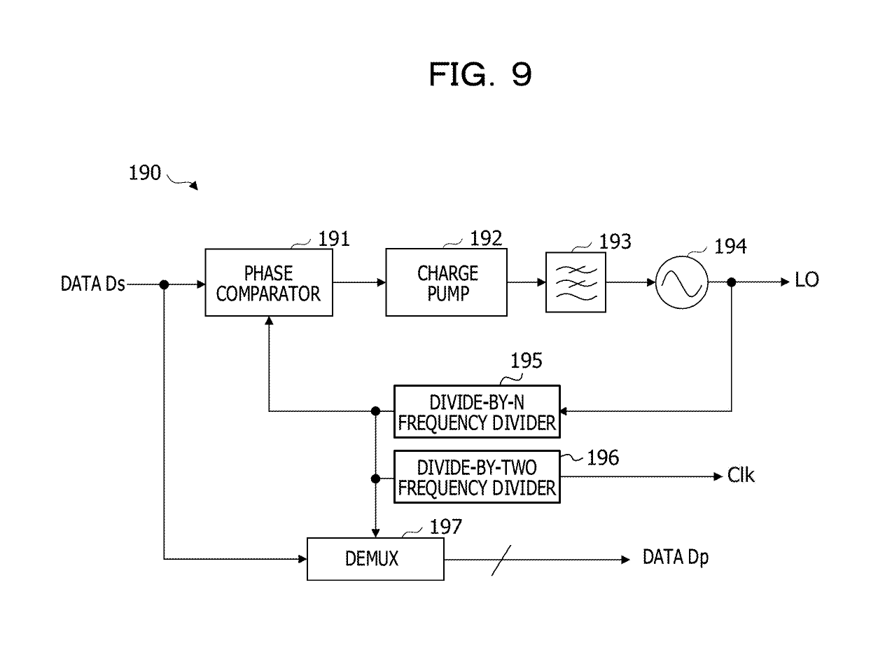

FIG. 9 is a diagram illustrating an example of a configuration of the CDR circuit 190. The CDR circuit 190 synchronizes the local signal LO (for example, local frequency FLO=66 GHz) and the data signal Ds (for example, data rate 6 Gbps). Therefore, the CDR circuit 190 has a phase synchronization circuit (PLL: Phase Locked Loop). Specifically, the CDR circuit 190 has a phase comparator 191, a charge pump 192, a low-pass filter 193, a voltage-controlled oscillator 194, and a divide-by-integer frequency divider 195 (divide-by-N frequency divider).

The divide-by-integer frequency divider 195 frequency-divides the local signal LO and generates and outputs a local frequency-divided signal having a frequency (for example, 6.68 GHz) lower than an oscillation frequency of the local signal LO. The phase comparator 191 compares a phase of the data signal Ds and a phase of the local frequency-divided signal and outputs a phase difference signal representing a phase difference thereof. The charge pump 192 outputs a control current that charges or discharges a capacitor in the low-pass filter 193 according to the phase difference signal from the phase comparator 191. The low-pass filter 193 is, for example, a primary low-pass filter including a resistive element and a capacitive element. The voltage-controlled oscillator 194 adjusts the frequency of the local signal LO to a predetermined target value (for example, 66.8 GHz) according to a voltage of the capacitive element in the low-pass filter 193 (specifically, a control voltage inputted into the voltage-controlled oscillator 194). The local signal LO is outputted to the phase modulator 140. In this way, it is possible to stabilize the local signal LO by negative feedback of the local signal LO.

The CDR circuit 190 generates not only the local signal LO but also the clock signal Clk. A divide-by-two frequency divider 196 provided in the CDR circuit 190 generates a clock signal Clk whose clock frequency Fs is 3.34 GHz by further frequency-dividing the local frequency-divided signal (for example, a signal of 6.68 GHz) outputted from the divide-by-integer frequency divider 195 by 2. The clock signal Clk is supplied to the impulse generator 131 of the impulse generating circuit 136.

A DEMUX 197 provided in the CDR circuit 190 is a demultiplexer that converts (serial-parallel converts) the serial data signal Ds into a parallel data signal Dp and outputs the data signal Dp to the phase modulator 140. The DEMUX 197 generates, for example, 2-bit data signal Dp of 3.34 GHz.

The data signal Dp outputted from the DEMUX 197 is a modulating signal supplied to the switch circuit 144 of the phase modulator 140. The phase modulator 140 phase-modulates the local signal LO according to the data signal Dp and outputs a phase-modulated local signal LOm. In this way, the phase modulator 140 phase-modulates the local signal LO according to the data signal Dp generated based on the data signal Ds.

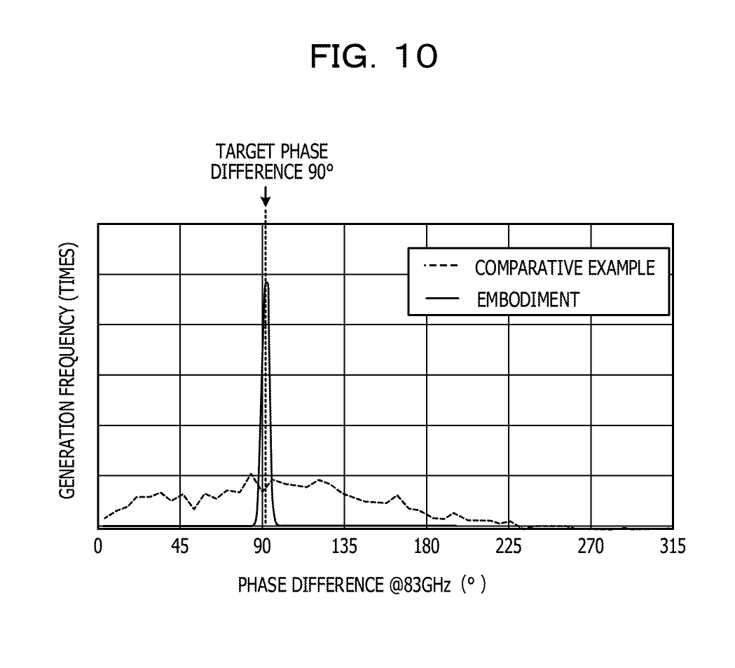

FIG. 10 is a diagram illustrating an example of a result of simulating a variation of phase difference. “Comparative example” represents the position modulation impulse generation circuit illustrated in FIG. 2, and “embodiment” represents the phase modulation impulse generation circuit illustrated in FIG. 3. FIG. 10 represents a histogram illustrating an example of a result of simulating multiple times a phase or a position of a signal generated by each impulse generation circuit based on element variation data in at least one wafer.

The horizontal axis represents a phase difference between a phase of a signal generated so as to have a target phase 90° by each impulse generation circuit and the target phase 90°. The vertical axis represents the number of samples of the impulse generation circuit. As illustrated in FIG. 10, a phase variation of impulse signal is more suppressed in the phase modulation impulse generation circuit that uses a phase modulator without using a plurality of delay devices than in the position modulation impulse generation circuit that uses a plurality of delay devices.

While the impulse generation circuit and the wireless communication apparatus have been described using the embodiment, the present disclosure is not limited to the embodiment described above. Various modifications and improvements such as combinations or replacements with parts or all of another embodiment may be made within the scope of the present disclosure.

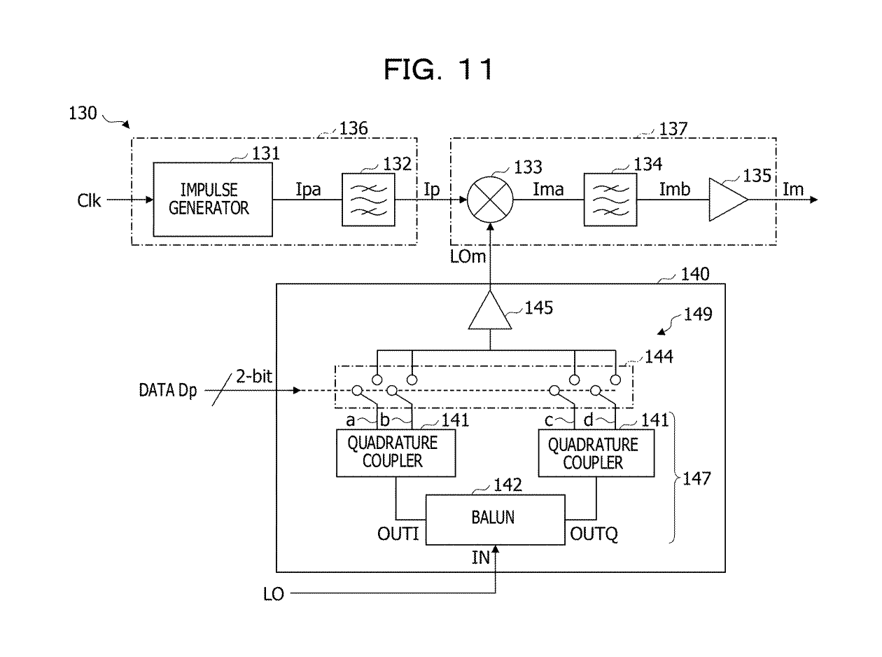

For example, the configuration of the passive circuit in the phase modulator 140 is not limited to that illustrated in FIG. 3. The phase modulator 140 illustrated in FIG. 11 has a passive circuit 149 formed including at least one passive element and generates the local signal LOm by phase-modulating the local signal LO by using the passive circuit 149.

The passive circuit 149 illustrated in FIG. 11 has a phase shift circuit 147 and a switch circuit 144. The phase shift circuit 147 is formed including one balun 142 and two quadrature couplers 141.

The balun 142 is a circuit that generates a first balun output signal and a second balun output signal whose phase is 180° different from that of the first balun output signal based on the local signal LO inputted from the input node IN. The balun 142 outputs the first balun output signal from the output node OUTI and outputs the second balun output signal from the output node OUTQ.

One quadrature coupler 141 generates a first coupler output signal and a second coupler output signal whose phase is 90° different from that of the first coupler output signal based on the first balun output signal outputted from the output node OUTI. The one quadrature coupler 141 outputs the first balun output signal whose phase is 0° as an output signal a and outputs the second coupler output signal whose phase is 90° as an output signal b.

The other quadrature coupler 141 generates a third coupler output signal and a fourth coupler output signal whose phase is 90° different from that of the third coupler output signal based on the second balun output signal outputted from the output node OUTQ. The other quadrature coupler 141 outputs the third coupler output signal whose phase is 180° as an output signal c and outputs the fourth coupler output signal whose phase is 270° as an output signal d.

Further, for example, the impulse generation circuit is not limited to use in a wireless communication system but may be used in a wired communication system. For example, in communication between circuits, each of a transmitter and a receiver may have the impulse generation circuit.

For example, when the frequency (transmission frequency Fc) of the impulse signal Im is 73.5 GHz, the frequency (local frequency FLO) of the local signal LOm and the frequency (intermediate frequency FIF) of the impulse signal Ip may be set to 58.8 GHz and 14.7 GHz, respectively. At this time, the frequency (clock frequency Fs) of the clock signal Clk is set to, for example, 2.94 GHz.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An impulse generation circuit, comprising:
a first impulse signal generation circuit configured to generate a first impulse signal based on a clock signal;
a phase modulator configured to generate a second local signal by phase-modulating a first local signal; and
a second impulse signal generation circuit configured to generate a second impulse signal by mixing the first impulse signal and the second local signal, the second impulse signal being a phase-modulated impulse signal.

2. The impulse generation circuit according to claim 1,
wherein the phase modulator includes a passive circuit formed by at least one transmission line,
wherein the phase modulator is configured to generate the second local signal by phase-modulating the first local signal with the passive circuit.

3. The impulse generation circuit according to claim 2,
wherein the passive circuit includes a phase shift circuit, the phase shift circuit being formed by at least one coupler and at least one balun,
wherein the phase shift circuit is configured to generate a plurality of output signals based on the first local signal, the plurality of output signals being different from each other in phase,
wherein the phase modulator is configured to generate the second local signal by switching the plurality of output signals.

4. The impulse generation circuit according to claim 3,
wherein the phase modulator includes
the at least one coupler includes a coupler configured to generate a first coupler-output signal and a second coupler-output signal in accordance with the first local signal, a phase difference between the first coupler-output signal and the second coupler-output signal being 90 degrees,
the at least one balun includes
a first balun configured to generate a first balun-output signal and a second balun-output signal in accordance with the first coupler-output signal, a phase difference between the first balun-output signal and the second balun-output signal being 180 degrees, and
a second balun configured to generate a third balun-output signal and a fourth balun-output signal in accordance with the second coupler-output signal, a phase difference between the third balun-output signal and the fourth balun-output signal being 180 degrees.

5. The impulse generation circuit according to claim 4, further comprising:
a synchronization circuit configured to synchronize the clock signal and the first local signal so that a ration between frequencies of the clock signal and the first local signal is an integer ration.

6. The impulse generation circuit according to claim 5,
wherein the synchronization circuit is configured to generate, based on a data signal entered into the synchronization circuit, the clock signal, the first local signal, and a modulating signal to be supplied to the phase modulator.

7. The impulse generation circuit according to claim 6,
wherein the first impulse signal generation circuit includes
an impulse generator configured to generate a pulse signal having a predetermined pulse width based on the clock signal, and
a first filter configured to output the first impulse signal by performing a filtering on the impulse signal,
wherein the second impulse signal generation circuit includes
a mixer configured to output a mixer-output signal generated by mixing the first impulse signal and the second local signal, and
a second filter configured to output the second impulse signal by performing a filtering on the mixer-output signal.

8. A wireless communication apparatus comprising:
a first impulse signal generation circuit configured to generate a first impulse signal based on a clock signal;
a phase modulator configured to generate a second local signal by phase-modulating a first local signal;
a second impulse signal generation circuit configured to generate a second impulse signal by mixing the first impulse signal and the second local signal, the second impulse signal being a phase-modulated impulse signal; and
an antenna configured to transmit the second impulse signal.

9. The wireless communication apparatus according to claim 8, further comprising:
a baseband circuit configured to transmit a baseband signal;
wherein the phase modulator is configured to phase-modulate the first local signal in accordance with the baseband signal.
